(19) United States
(12) Patent Application Publication
(10) Pub. No.: US 2026/0135596 A1
(43) Pub. Date: May 14, 2026

(54) METHOD AND APPARATUS FOR SECURELY COMMUNICATING CHANNEL STATE INFORMATION BETWEEN AN ACCESS POINT AND AN UNASSOCIATED STATION

(71) Applicant: NOKIA TECHNOLOGIES OY, Espoo (FI)

(72) Inventors: Orhan Okan MUTGAN, Munich (DE); Mario COSTA, Espoo (FI); Salvatore TALARICO, Sunnyvale, CA (US); Juhyung LEE, Santa Clara, CA (US); Prabodh VARSHNEY, Irving (TX); Mika KASSLIN, Espoo (FI); Mikhail LIUBOGOSHCHEV, Munich (DE); Oleg CHISTYAKOV, Espoo (FI); Enrico RANTALA, Helsinki (FI); Eda GENC, Espoo (FI); Kerstin JOHNSSON, Palo Alto, CA (US); Behnam DEZFOULI, San Jose, CA (US); Klaus Franz DOPPLER, Albany, CA (US)

(21) Appl. No.: 18/941,247

(22) Filed: Nov. 8, 2024

(51) Int. Cl. H04B 7/06; H04W 24/10

(52) U.S. Cl. CPC H04B 7/0626; H04W 24/10

(57) ABSTRACT

A method, apparatus and computer program product are provided from the perspective of a station, an access point and an intermediate device in order to provide a channel state information (CSI) report from a station to an access point with which this station is unassociated while protecting the privacy of the CSI report. Even though the CSI report is to be transmitted from a station to an access point with which the station is unassociated, the CSI report is transmitted via one or more secure connection links, such as by being encrypted while being transmitted via the one or more connection links. The CSI report is therefore not exposed via an unsecured connection link to a third party, thereby protecting the privacy of the CSI report.

### TECHNOLOGICAL FIELD

An apparatus, method and computer program product are provided in accordance with an example embodiment in order to facilitate the secure exchange of channel state information (CSI) between an access point and an unassociated station, such as for coordinated beamforming (CBF) with null steering.

### BACKGROUND

Some wireless technologies, such as Wi-Fi, rely upon communication between stations (STAs) and access points (APs) to provide network access for the STAs and communication therewith. In a number of environments, there may be multiple access points and multiple stations with certain stations being associated with and having a secure connection with respective access points, but not with other access points.

For example, FIG. 1 depicts an environment in which two access points AP1 and AP2 communicate with two stations, STA1 and STA2. In this example, STA1 is associated with a AP1 and has a secure connection link therewith, while STA2 is associated with AP2 and has a secure connection link therewith. However, when an access point, such as AP1, is in communication with an associated station, such as STA1 via communication channel H11, interference may be created for an unassociated station, such as for STA2 through communication channel H12 between AP1 and STA2. Similarly, when AP2 is in communication with associated station STA2 via communication channel H22, interference may be created for STA1 via communication channel H21 between AP2 and STA1.

The interference between an access point and a station which is not associated with the access point diminishes the quality of communication for the station. As such, coordinated beamforming (CBF) with null steering has been developed to reduce or eliminate interference between an access point and stations which are not associated with the access point. CBF with null steering configures multiple access points such that each access point directs its transmissions to the station that is associated with the access point, while creating nulls directed toward other stations that are not associated with the access point. By creating nulls directed toward the other stations that are not associated with the access point, the other stations receive no signals from the access point other than the noise floor. As a result, communications between the other stations and other access points with which the other stations are associated are not degraded by the interference.

With reference to FIG. 1, for example, CBF with null steering causes the interference channels H12 and H21 to be nulled with the access points AP1 and AP2, instead, being configured to transmit instead toward STA1 and STA2, respectively, which are associated with AP1 and AP2. As such, STA1 only receives transmissions from AP1 and STA2 only receives transmissions from AP2, thereby avoiding degradation otherwise created by interfering signals.

In order to be configured such that nulls are steered toward a station that is not associated with an access point, the access point, such as AP1 and AP2, must acquire the channel state information (CSI), from the stations, such as STA1 and STA2, with which a communication channel would be established. Based on the CSI from the stations, the access points can configure precoding vectors that take into account the corresponding interference channel and that therefore steer a null toward the station that is not associated with the access point. With respect to the example of FIG. 1, AP1 and AP2 therefore need the CSI from both STA1 and STA2 in order to define a precoding vector to steer a null toward the unassociated station.

By way of example in which AP1 of FIG. 1 determines the CSI of communication channel H11 and the CSI interference channel H12, the precoding configuration for AP1 may be defined such that the transmissions from AP1 are directed only to STA1 that is associated with AP1, while creating a null directed toward unassociated STA2, thereby avoiding interference for STA2. Similarly, if AP2 determines the CSI of communication channel H22 and the CSI of interference channel H21, the precoding vector for AP2 may be determined such that the transmissions from AP2 are directed only to STA2 that is associated with AP2, while directing a null toward unassociated STA1 and avoiding interference for STA1.

In order to acquire information regarding a wireless channel, including the CSI of the channel, sounding of a communication channel between a transmitter, such as an access point, and a receiver, such as a station, may be performed. The Wi-Fi specification defines sounding between a single access point and either single or multiple stations associated with the access point. For single station sounding depicted in FIG. 2, the access point initially sends a Null Data Packet Announcement (NDPA) followed by a Null Data Packet (NDP). In response, the station returns the CSI as measured across the communication channel between the access point and the station during the NDP.

For multi-station sounding depicted in FIG. 3, the access point sends an NDPA followed by an NDP. A respective station, e.g., STA1, measures the CSI across the communication channel between the access point and the respective station during the NDP and then provides the CSI in response to the NDP. The access point then sequentially polls each STA using a Beamforming Report Poll (BFRP) to request that each station, in turn, provides the CSI for its communication channel with the access point.

The sounding procedure described with respect to FIGS. 2 and 3 varies slightly across the different generations of the Wi-Fi specification, such as across 802.11n, 802.11ac, 802.11ax, 802.11be, etc. However, the sounding procedure for each generation of the Wi-Fi specification generally follows the procedures depicted in FIGS. 2 and 3, although the format of the CSI frame that is provided by a station may vary depending upon the generation of the Wi-Fi specification. For example, 802.11n may utilize a non-compressed beamforming frame for the CSI report while 802.11ac may utilize a Very High Throughput (VHT) compressed beamforming frame. Additionally, 802.11ax may utilize a High Efficiency (HE) compressed beamforming frame/Channel Quality Indicator (CQI) frame, while 802.11be may utilize Extremely High Throughput (EHT) compressed beamforming frame/CQI frame.

The sounding procedure defined by the Wi-Fi specification is effective for defining the CSI of communication channel(s) between an access point and one or more stations. However, the Wi-Fi specification does not currently provide for sounding procedures involving multiple access points, each of which is configured to communication with one or more stations.

### BRIEF SUMMARY

A method, apparatus and computer program product are provided in order to provide a CSI report from a station to an access point with which the station is unassociated while protecting the privacy of the CSI report. Even though the CSI report is to be transmitted from a station to an access point with which the station is unassociated, the CSI report will be transmitted via one or more secure connection links, such as by being encrypted while being transmitted via one or more connection links. As such, the CSI report may transmitted be in a manner that does not expose the CSI report via an unsecured connection link to a third party, thereby protecting the privacy of the CSI report.

In one aspect of the present disclosure, an apparatus is provided that includes at least one processor and at least one memory storing instructions that, when executed by the at least one processor, cause the apparatus to determine channel state information (CSI) between a first station and a second access point with which the first station is unassociated. The instructions, when executed by the at least one processor, cause the apparatus to cause a report of the CSI between the first station and the second access point to be transmitted from the first station toward the second access point with which the first station is unassociated via one or more secure connection links to provide privacy protection for the report of the CSI between the first station and the second access point.

The instructions, when executed by the at least one processor, further cause the apparatus of an example embodiment to determine CSI between the first station and a first access point with which the first station is associated and to cause a report of the CSI between the first station and the first access point to be transmitted to the first access point via a secure connection link. In one embodiment, the instructions, when executed by the at least one processor, cause the apparatus to cause the report of the CSI between the first station and the second access point to be transmitted from the first station toward the second access point by causing the report of the CSI between the first station and the second access point to be transmitted from the first station to the first access point via a first secure connection link for subsequent provision from the first access point to the second access point via a second secure connection link. The instructions, when executed by the at least one processor, cause the apparatus of an example embodiment to cause the report of the CSI between the first station and the first access point to be transmitted to the first access point and to cause the report of the CSI between the first station and the second access point to be transmitted from the first station toward the second access point by causing the reports of the CSI between the first station and the first access point and the CSI between the first station and the second access point to both be transmitted from the first station to the first access point via a first secure connection link for subsequent provision of the report of the CSI between the first station and the second access point from the first access point to the second access point via a second secure connection link.

The instructions, when executed by the at least one processor, cause the apparatus of an example embodiment to cause the report of the CSI between the first station and the second access point to be transmitted from the first station toward the second access point by causing the report of the CSI between the first station and the second access point to be transmitted from the first station to a second station via a first secure connection link for subsequent provision from the second station to the second access point via a second secure connection link. In one embodiment, the instructions, when executed by the at least one processor, cause the apparatus to cause the report of the CSI between the first station and the first access point to be transmitted to the first access point and to cause the report of the CSI between the first station and the second access point to be transmitted toward the second station without receipt of signaling from the first and second access points therebetween. The instructions, when executed by the at least one processor, further cause the apparatus of an example embodiment to establish a secure connection link between the first station and the second access point with which the first station is unassociated prior to causing the report of the CSI between the first station and the second access point to be transmitted from the first station toward the second access point by causing the report of the CSI between the first station and the second access point to be transmitted to the second access point via the secure connection link established therebetween.

In an example embodiment, the instructions, when executed by the at least one processor, further cause the apparatus to establish a secure connection link between the first station and the second access point with which the first station is unassociated prior to causing the reports of the CSI between the first station and the first access point and between the first station and the second access point to be transmitted to the first access point and the second access point, respectively, without receipt of signaling from the first and second access points therebetween. In this example embodiment, the instructions, when executed by the at least one processor, further cause the apparatus to receive a signal from the first access point requesting establishment of the secure connection link between the first station and the second access point with which the first station is unassociated.

In another aspect, a method is provided that includes determining channel state information (CSI) between a first station and a second access point with which the first station is unassociated and causing a report of the CSI between the first station and the second access point to be transmitted from the first station toward the second access point with which the first station is unassociated via one or more secure connection links to provide privacy protection for the report of the CSI between the first station and the second access point. In an example embodiment the method also includes determining CSI between the first station and a first access point with which the first station is associated and causing a report of the CSI between the first station and the first access point to be transmitted to the first access point via a secure connection link.

In one embodiment, causing the report of the CSI between the first station and the second access point to be transmitted from the first station toward the second access point includes causing the report of the CSI between the first station and the second access point to be transmitted from the first station to the first access point via a first secure connection link for subsequent provision from the first access point to the second access point via a second secure connection link. In an example embodiment, causing the report of the CSI between the first station and the first access point to be transmitted to the first access point and causing the report of the CSI between the first station and the second access point to be transmitted from the first station toward the second access point includes causing the reports of the CSI between the first station and the first access point and the CSI between the first station and the second access point to both be transmitted from the first station to the first access point via a first secure connection link for subsequent provision of the report of the CSI between the first station and the second access point from the first access point to the second access point via a second secure connection link.

In an example embodiment, causing the report of the CSI between the first station and the second access point to be transmitted from the first station toward the second access point includes causing the report of the CSI between the first station and the second access point to be transmitted from the first station to a second station via a first secure connection link for subsequent provision from the second station to the second access point via a second secure connection link. In one embodiment, causing the report of the CSI between the first station and the first access point to be transmitted to the first access point includes causing the report of the CSI between the first station and the second access point to be transmitted toward the second station without receipt of signaling from the first and second access points therebetween. The method of an example embodiment further includes establishing a secure connection link between the first station and the second access point with which the first station is unassociated prior to causing the report of the CSI between the first station and the second access point to be transmitted from the first station toward the second access point by causing the report of the CSI between the first station and the second access point to be transmitted to the second access point via the secure connection link established therebetween.

The method of an example embodiment also includes establishing a secure connection link between the first station and the second access point with which the first station is unassociated prior to causing the reports of the CSI between the first station and the first access point and between the first station and the second access point to be transmitted to the first access point and the second access point, respectively, without receipt of signaling from the first and second access points therebetween. In this example embodiment, the method also includes receiving a signal from the first access point requesting establishment of the secure connection link between the first station and the second access point with which the first station is unassociated.

In a further aspect, a computer program product is provided that includes at least one non-transitory computer-readable storage medium having computer-executable program code portions stored therein with the computer-executable program code portions including program code instructions configured to determine channel state information (CSI) between a first station and a second access point with which the first station is unassociated. The computer-executable program code portions also include program code instructions configured to cause a report of the CSI between the first station and the second access point to be transmitted from the first station toward the second access point with which the first station is unassociated via one or more secure connection links to provide privacy protection for the report of the CSI between the first station and the second access point.

The computer-executable program code portions of an example embodiment also include program code instructions configured to determine CSI between the first station and a first access point with which the first station is associated and to cause a report of the CSI between the first station and the first access point to be transmitted to the first access point via a secure connection link. In one embodiment, the program code instructions configured to cause the report of the CSI between the first station and the second access point to be transmitted from the first station toward the second access point include program code instructions configured to cause the report of the CSI between the first station and the second access point to be transmitted from the first station to the first access point via a first secure connection link for subsequent provision from the first access point to the second access point via a second secure connection link. The program code instructions of an example embodiment are configured to cause the report of the CSI between the first station and the first access point to be transmitted to the first access point and to cause the report of the CSI between the first station and the second access point to be transmitted from the first station toward the second access point by causing the reports of the CSI between the first station and the first access point and the CSI between the first station and the second access point to both be transmitted from the first station to the first access point via a first secure connection link for subsequent provision of the report of the CSI between the first station and the second access point from the first access point to the second access point via a second secure connection link.

The program code instructions of an example embodiment are configured to cause the report of the CSI between the first station and the second access point to be transmitted from the first station toward the second access point by causing the report of the CSI between the first station and the second access point to be transmitted from the first station to a second station via a first secure connection link for subsequent provision from the second station to the second access point via a second secure connection link. In one embodiment, the program code instructions are configured to cause the report of the CSI between the first station and the first access point to be transmitted to the first access point and to cause the report of the CSI between the first station and the second access point to be transmitted toward the second station without receipt of signaling from the first and second access points therebetween. The program code instructions of an example embodiment are also configured to establish a secure connection link between the first station and the second access point with which the first station is unassociated prior to causing the report of the CSI between the first station and the second access point to be transmitted from the first station toward the second access point by causing the report of the CSI between the first station and the second access point to be transmitted to the second access point via the secure connection link established therebetween.

In an example embodiment, the program code instructions of an example embodiment are configured to establish a secure connection link between the first station and the second access point with which the first station is unassociated prior to causing the reports of the CSI between the first station and the first access point and between the first station and the second access point to be transmitted to the first access point and the second access point, respectively, without receipt of signaling from the first and second access points therebetween. In this example embodiment, the program code instructions may also be configured to receive a signal from the first access point requesting establishment of the secure connection link between the first station and the second access point with which the first station is unassociated.

In yet another aspect, an apparatus is provided that includes means for determining channel state information (CSI) between a first station and a second access point with which the first station is unassociated and means for causing a report of the CSI between the first station and the second access point to be transmitted from the first station toward the second access point with which the first station is unassociated via one or more secure connection links to provide privacy protection for the report of the CSI between the first station and the second access point. In an example embodiment the apparatus also includes means for determining CSI between the first station and a first access point with which the first station is associated and means for causing a report of the CSI between the first station and the first access point to be transmitted to the first access point via a secure connection link.

In one embodiment, the means for causing the report of the CSI between the first station and the second access point to be transmitted from the first station toward the second access point includes means for causing the report of the CSI between the first station and the second access point to be transmitted from the first station to the first access point via a first secure connection link for subsequent provision from the first access point to the second access point via a second secure connection link. In an example embodiment, the means for causing the report of the CSI between the first station and the first access point to be transmitted to the first access point and the means for causing the report of the CSI between the first station and the second access point to be transmitted from the first station toward the second access point includes means for causing the reports of the CSI between the first station and the first access point and the CSI between the first station and the second access point to both be transmitted from the first station to the first access point via a first secure connection link for subsequent provision of the report of the CSI between the first station and the second access point from the first access point to the second access point via a second secure connection link.

In an example embodiment, the means for causing the report of the CSI between the first station and the second access point to be transmitted from the first station toward the second access point includes means for causing the report of the CSI between the first station and the second access point to be transmitted from the first station to a second station via a first secure connection link for subsequent provision from the second station to the second access point via a second secure connection link. In one embodiment, the means for causing the report of the CSI between the first station and the first access point to be transmitted to the first access point includes means for causing the report of the CSI between the first station and the second access point to be transmitted toward the second station without receipt of signaling from the first and second access points therebetween. The apparatus of an example embodiment further includes means for establishing a secure connection link between the first station and the second access point with which the first station is unassociated prior to causing the report of the CSI between the first station and the second access point to be transmitted from the first station toward the second access point by causing the report of the CSI between the first station and the second access point to be transmitted to the second access point via the secure connection link established therebetween.

The apparatus of an example embodiment also includes means for establishing a secure connection link between the first station and the second access point with which the first station is unassociated prior to causing the reports of the CSI between the first station and the first access point and between the first station and the second access point to be transmitted to the first access point and the second access point, respectively, without receipt of signaling from the first and second access points therebetween. In this example embodiment, the apparatus also includes means for receiving a signal from the first access point requesting establishment of the secure connection link between the first station and the second access point with which the first station is unassociated.

In one aspect of the present disclosure, an apparatus is provided that includes at least one processor and at least one memory storing instructions that, when executed by the at least one processor, cause the apparatus to receive a report of channel state information (CSI) between a first station and a second access point with which the first station is unassociated via one or more secure connection links to provide privacy protection for the report of the CSI between the first station and the second access point. The instructions that, when executed by the at least one processor, also cause the apparatus to provide for coordinated beamforming (CBF) with null steering based at least in part upon the CSI between the first station and the second access point.

The instructions, when executed by the at least one processor, further cause the apparatus of an example embodiment to receive, from a second station, a report of the CSI between the second station and the second access point with which the second station is associated via a secure connection link. In this embodiment, the CBF with null steering is also based at least in part upon the CSI between the second station and the second access point. In one embodiment, the instructions, when executed by the at least one processor, cause the apparatus to receive the report of the CSI between the first station and the second access point from a first access point via a secure connection link between the first and second access points. The instructions, when executed by the at least one processor, cause the apparatus of an example embodiment to receive the report of the CSI between the first station and the second access point from the second station via the secure connection link between the second station and the second access point. In an example embodiment, the instructions, when executed by the at least one processor, further cause the apparatus to establish a secure connection link between the first station and the second access point with which the first station is unassociated prior to receiving the report of the CSI between the first station and the second access point from the first station via the secure connection link established therebetween.

In another aspect, a method is provided that includes receiving a report of channel state information (CSI) between a first station and a second access point with which the first station is unassociated via one or more secure connection links to provide privacy protection for the report of the CSI between the first station and the second access point. The method also includes providing for coordinated beamforming (CBF) with null steering based at least in part upon the CSI between the first station and the second access point.

The method of an example embodiment also includes receiving, from a second station, a report of the CSI between the second station and the second access point with which the second station is associated via a secure connection link. In this embodiment, the CBF with null steering is also based at least in part upon the CSI between the second station and the second access point. In one embodiment, the method includes receiving the report of the CSI between the first station and the second access point from a first access point via a secure connection link between the first and second access points. The method of an example embodiment includes receiving the report of the CSI between the first station and the second access point from the second station via the secure connection link between the second station and the second access point. In an example embodiment, the method also includes establishing a secure connection link between the first station and the second access point with which the first station is unassociated prior to receiving the report of the CSI between the first station and the second access point from the first station via the secure connection link established therebetween.

In a further aspect,, a computer program product is provided that includes at least one non-transitory computer-readable storage medium having computer-executable program code portions stored therein with the computer-executable program code portions including program code instructions configured to receive a report of channel state information (CSI) between a first station and a second access point with which the first station is unassociated via one or more secure connection links to provide privacy protection for the report of the CSI between the first station and the second access point. The computer-executable program code portions also include program code instructions configured to provide for coordinated beamforming (CBF) with null steering based at least in part upon the CSI between the first station and the second access point.

The computer-executable program code portions of an example embodiment also include program code instructions configured to receive, from a second station, a report of the CSI between the second station and the second access point with which the second station is associated via a secure connection link. In this embodiment, the CBF with null steering is also based at least in part upon the CSI between the second station and the second access point. In one embodiment, the computer-executable program code portions include program code instructions configured to receive the report of the CSI between the first station and the second access point from a first access point via a secure connection link between the first and second access points. The computer-executable program code portions of an example embodiment also include program code instructions configured to receive the report of the CSI between the first station and the second access point from the second station via the secure connection link between the second station and the second access point. In an example embodiment, the computer-executable program code portions include program code instructions configured to establish a secure connection link between the first station and the second access point with which the first station is unassociated prior to receiving the report of the CSI between the first station and the second access point from the first station via the secure connection link established therebetween.

In yet another aspect, an apparatus is provided that includes means for receiving a report of channel state information (CSI) between a first station and a second access point with which the first station is unassociated via one or more secure connection links to provide privacy protection for the report of the CSI between the first station and the second access point. The apparatus also includes means for providing for coordinated beamforming (CBF) with null steering based at least in part upon the CSI between the first station and the second access point.

The apparatus of an example embodiment also includes means for receiving, from a second station, a report of the CSI between the second station and the second access point with which the second station is associated via a secure connection link. In this embodiment, the CBF with null steering is also based at least in part upon the CSI between the second station and the second access point. In one embodiment, the apparatus includes means for receiving the report of the CSI between the first station and the second access point from a first access point via a secure connection link between the first and second access points. The apparatus of an example embodiment includes means for receiving the report of the CSI between the first station and the second access point from the second station via the secure connection link between the second station and the second access point. In an example embodiment, the apparatus also includes means for establishing a secure connection link between the first station and the second access point with which the first station is unassociated prior to receiving the report of the CSI between the first station and the second access point from the first station via the secure connection link established therebetween.

In one aspect of the present disclosure, an apparatus is provided that includes at least one processor and at least one memory storing instructions that, when executed by the at least one processor, cause the apparatus to receive, from a first station, a report of channel state information (CSI) between the first station and a second access point with which the first station is unassociated via a secure connection link. The instructions, when executed by the at least one processor, also cause the apparatus to cause the report of the CSI between the first station and the second access point with which the first station is unassociated to be transmitted to the second access point via another secure connection link so as to provide privacy protection for the report of the CSI between the first station and the second access point.

The apparatus of an example embodiment is embodied by a first access point having secure connection links with the first station and with the second access point. The instructions, when executed by the at least one processor, may cause the apparatus of this embodiment to communicate with the second access point to determine that the report of the CSI is to be provided by the first station. The instructions, when executed by the at least one processor, further cause the apparatus of an example embodiment to receive, from the first station, a report of the CSI between the first station and a first access point with which the first station is associated via a secure connection link. The instructions, when executed by the at least one processor, may cause the apparatus of this embodiment to receive the report of the CSI between the first station and the first access point and to receive the report of the CSI between the first station and the second access point without additional signaling therebetween. The apparatus of another example embodiment is embodied by a second station having secure connection links with the first station and the second access point.

In another aspect, a method is provided that includes receiving, from a first station, a report of channel state information (CSI) between the first station and a second access point with which the first station is unassociated via a secure connection link. The method also includes causing the report of the CSI between the first station and the second access point with which the first station is unassociated to be transmitted to the second access point via another secure connection link so as to provide privacy protection for the report of the CSI between the first station and the second access point.

The method of an example embodiment may be implemented by a first access point having secure connection links with the first station and with the second access point. The method of this embodiment may include communicating with the second access point to determine that the report of the CSI is to be provided by the first station. The method of an example embodiment also includes receiving, from the first station, a report of the CSI between the first station and a first access point with which the first station is associated via a secure connection link. The method of this embodiment may also include receiving the report of the CSI between the first station and the first access point and receiving the report of the CSI between the first station and the second access point without additional signaling therebetween. The method of another example embodiment may be implemented by a second station having secure connection links with the first station and the second access point.

In a further aspect, a computer program product is provided that includes at least one non-transitory computer-readable storage medium having computer-executable program code portions stored therein with the computer-executable program code portions including program code instructions configured to receive, from a first station, a report of channel state information (CSI) between the first station and a second access point with which the first station is unassociated via a secure connection link. The computer-executable program code portions also include program code instructions configured to cause the report of the CSI between the first station and the second access point with which the first station is unassociated to be transmitted to the second access point via another secure connection link so as to provide privacy protection for the report of the CSI between the first station and the second access point.

The computer program product of an example embodiment is embodied by or associated with a first access point having secure connection links with the first station and with the second access point. The computer-executable program code portions of this example embodiment may also include program code instructions configured to determine that the report of the CSI is to be provided by the first station. The computer-executable program code portions of an example embodiment also include program code instructions configured to to receive, from the first station, a report of the CSI between the first station and a first access point with which the first station is associated via a secure connection link. In this embodiment, the computer-executable program code portions may include program code instructions configured to to receive the report of the CSI between the first station and the first access point and program code instructions configured to receive the report of the CSI between the first station and the second access point without additional signaling therebetween. The computer program product of another example embodiment is embodied by or associated with a second station having secure connection links with the first station and the second access point.

In yet another aspect, an apparatus is provided that includes means for receiving, from a first station, a report of channel state information (CSI) between the first station and a second access point with which the first station is unassociated via a secure connection link. The apparatus also includes means for causing the report of the CSI between the first station and the second access point with which the first station is unassociated to be transmitted to the second access point via another secure connection link so as to provide privacy protection for the report of the CSI between the first station and the second access point.

The apparatus of an example embodiment may be embodied by a first access point having secure connection links with the first station and with the second access point. The apparatus of this embodiment may include means for communicating with the second access point to determine that the report of the CSI is to be provided by the first station. The apparatus of an example embodiment also includes means for receiving, from the first station, a report of the CSI between the first station and a first access point with which the first station is associated via a secure connection link. The apparatus of this embodiment may also include means for receiving the report of the CSI between the first station and the first access point and receiving the report of the CSI between the first station and the second access point without additional signaling therebetween. The apparatus of another example embodiment may be embodied by a second station having secure connection links with the first station and the second access point.

### BRIEF DESCRIPTION OF THE DRAWINGS

In the following, certain embodiments of the present disclosure will be described in greater detail with reference to the accompanying drawings, in which:

FIG. 1 illustrates interference created by a communication channel between an access point and an unassociated station;

FIG. 2 illustrates a sounding procedure between a single access point and a single station;

FIG. 3 illustrates a sounding procedure between a single access point and multiple stations;

FIG. 4 illustrates a wireless communication system including a pair of access points and a plurality of stations;

FIG. 5 is a block diagram of an apparatus that may be configured in accordance with an example embodiment;

FIG. 6 illustrates a sequential sounding procedure between two access points and two stations;

FIG. 7 illustrates a joint sounding procedure between two access points and two stations;

FIG. 8 is a flow diagram illustrating operations performed in accordance with an example embodiment, such as by apparatus of FIG. 5 when embodied or otherwise associated with a station;

FIG. 9 is a flow diagram illustrating operations performed in accordance with an example embodiment, such as by apparatus of FIG. 5 when embodied or otherwise associated with an access point;

FIG. 10 is a flow diagram illustrating operations performed in accordance with an example embodiment, such as by apparatus of FIG. 5 when embodied or otherwise associated with an intermediate device;

FIG. 11 illustrates a sequential sounding procedure in accordance with an example embodiment in which an access point relays a CSI report relating to another access point via secure connection links;

FIG. 12 illustrates a joint sounding procedure in accordance with an example embodiment in which an access point relays a CSI report relating to another access point via secure connection links;

FIG. 13 illustrates a sequential sounding procedure in accordance with an example embodiment in which a station relays a CSI report relating to another station via secure connection links;

FIG. 14 illustrates a joint sounding procedure in accordance with an example embodiment in which a station relays a CSI report relating to another station via secure connection links;

FIG. 15 illustrates a sequential sounding procedure in accordance with an example embodiment in which a security context is established between an access point and a station that are unassociated before transmitting a CSI report therebetween;

FIG. 16 illustrates a joint sounding procedure in accordance with an example embodiment in which a security context is established between an access point and a station that are unassociated before transmitting a CSI report therebetween;

FIG. 17 illustrates the provision of a beacon frame including an encryption key from an access point to a station in order to establish the security context of FIGS. 15 and 16;

FIG. 18 illustrates the provision of a security establishment negotiation between an access point and a station in order to establish the security context of FIGS. 15 and 16;

FIG. 19 illustrates a frame in accordance with an example embodiment via which a station transmits only a CSI report to an access point with which the station is associated;

FIG. 20 illustrates a frame in accordance with an example embodiment via which a station transmits one CSI report to an access point with which the station is associated and another CSI report to another access point with which the station is not associated;

FIG. 21 illustrates a frame in accordance with another example embodiment via which a station transmits one CSI report to an access point with which the station is associated and another CSI report to another access point with which the station is not associated;

FIG. 22 illustrates a frame in accordance with a further example embodiment via which a station transmits one CSI report to an access point with which the station is associated and another CSI report to another access point with which the station is not associated;

FIG. 23 illustrates a frame in accordance with an example embodiment via which a station transmits a CSI report for another station to an access point with which the station is associated;

FIG. 24 illustrates a frame in accordance with another example embodiment via which a station transmits a CSI report for another station to an access point with which the station is associated;

FIG. 25 illustrates a frame in accordance with an example embodiment via which an access point transmits a CSI report for another access point to the other access point;

FIG. 26 illustrates a frame in accordance with an example embodiment via which a first station transmits a CSI report to a second station to be relayed to an access point with which the second station is associated; and

FIG. 27 illustrates a frame in accordance with another example embodiment via which a first station transmits a CSI report to a second station to be relayed to an access point with which the second station is associated.

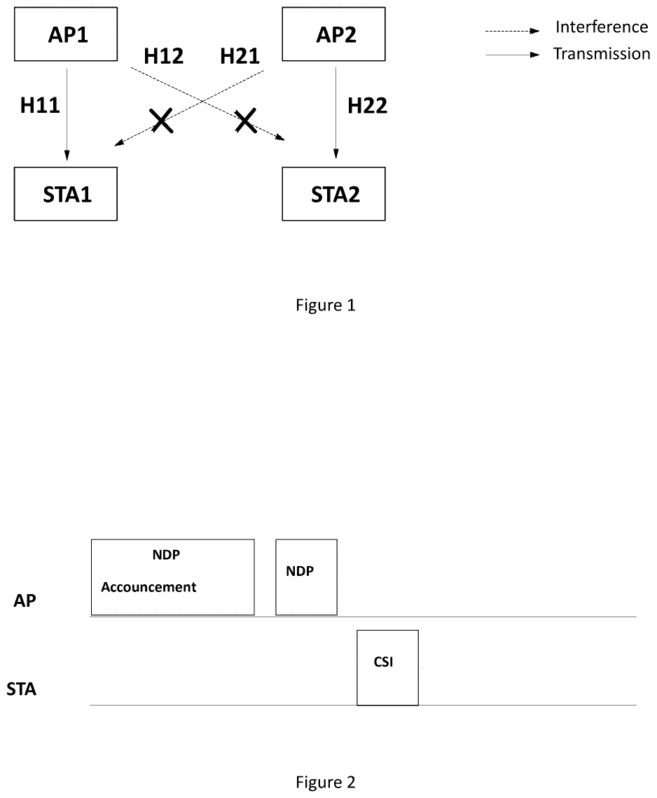

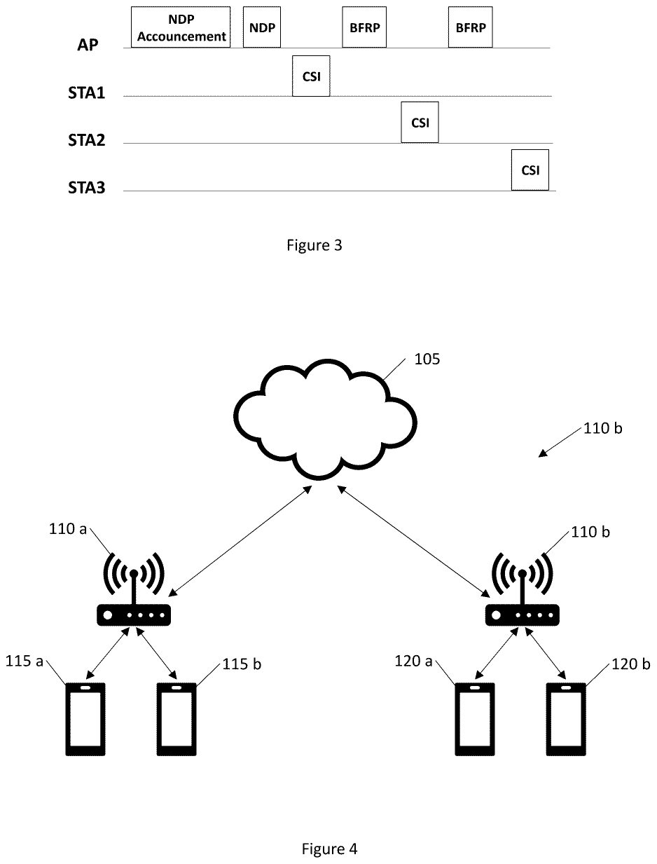

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with example embodiments of the present disclosure. Thus, use of any such terms should not be taken to limit the spirit and scope of example embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

A communications system may be deployed in a wireless local area network (e.g., WLAN, Wi-Fi, etc.), for example, based on IEEE 802.11 standards and/or related drafts, such as 802.11-2020, 802.11ac, 802.11ax, 802.11be, 802.11bn, and/or others. That is, the system may be an example of a WLAN system. The WLAN system may support wireless communications between one or more communications devices in accordance with one or more Wi-Fi protocols. In some examples, Wi-Fi communications may occur via one or more radio frequency bands, such as about 2.4 GHz radio frequency band and/or about 5 GHz radio frequency band. In some such examples, each radio frequency band may support one or more channels over which data may be communicated. In some examples, multiple devices may use multiple channels to communicate over the WLAN simultaneously.

A WLAN system may include one or more communications devices, such as one or more access points (APs) and/or one or more non-AP stations (STAs). That is, a device configured to support one or more Wi-Fi protocols may be an example of an AP (e.g., may operate in accordance with an AP mode) and/or may be an example of a STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more non-AP STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID).

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity which may be configured to act as a network manager. In some examples, the network manager is an entity in cloud-based entity which may reside either in private cloud or in public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more non-AP STAs (also referred to as clients) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a non-AP STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDUs, wherein a payload of a PDU may comprise user data, control data, management data, and/or other data. In some examples, a WLAN system may implement one or more security protocols to protect the confidentiality, integrity, and availability of Wi-Fi communications.

A WLAN system may be configured with various types of services sets, for example, such as basic service set (BSS) and/or an extended service set (ESS). A BSS may be comprised of an AP and one or more client devices (e.g., non-AP STAs) associated with the AP. The one or more client devices may have one or more common PHY medium access characteristics (e.g., radio frequency, modulation scheme, security settings, and/or the like). A BSS identifier (BSSID) may define the BSS such that the one or more client devices of the BSS share the same BSSID.

One example of a communications system 100 in which an example embodiment may be deployed is depicted in FIG. 4. The communications system 100 may be utilized for a variety of applications. For example, the communications system 100 may include at least one cloud network 105, at least one AP such as the APs 110a and 110b (collectively “110”), at least one client device (e.g., non-AP STA) such as the client devices 115a and 115b (collectively “115”) connected to the AP 110a and the client devices 120a and 120b (collectively “120”) connected to the AP 110b, and/or other components. The APs 110 may be mobile access points (mAPs) with limited functionality. In some examples, a configuration comprising a mAP and a client device may be implemented as part of a peer-to-peer connection, for example, as in Wi-Fi Direct. In some examples, a device is able to simultaneously operate as client device and as an AP. One such an example case is a multi-AP network which comprises of two or more devices which act as APs and use Wi-Fi for the wireless backhaul connectivity based on the non-AP STA—AP connection model.

Wireless communication systems may include access points that provide wireless connectivity according to the Wi-Fi standards, which are a subset of the IEEE 802 family of standards. For example, the medium access control (MAC) and physical layer (PHY) specifications for Wi-Fi access points are defined by IEEE 802.11 for transmitting and receiving data in frequency bands such as 2.4 gigahertz (GHz), 3.6 GHz, 5 GHz, 6 GHz, 60 GHz, and/or the like. Wi-Fi access points may transmit one or more frames. For example, the one or more frames may include data frames, management frames, and/or control frames, which may be transmitted in unicast messages, broadcast messages, or multicast messages. The 802.11 standards define an inter-frame space (IFS) as the nominal time (in microseconds, μs) that the MAC and PHY require in order to receive the last symbol of a frame, process the frame, and respond with the first symbol of the earliest possible response frame.

In FIG. 4, client devices 115 and/or 120 are configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, user equipment (UEs), and/or other entities suitable for such usage.

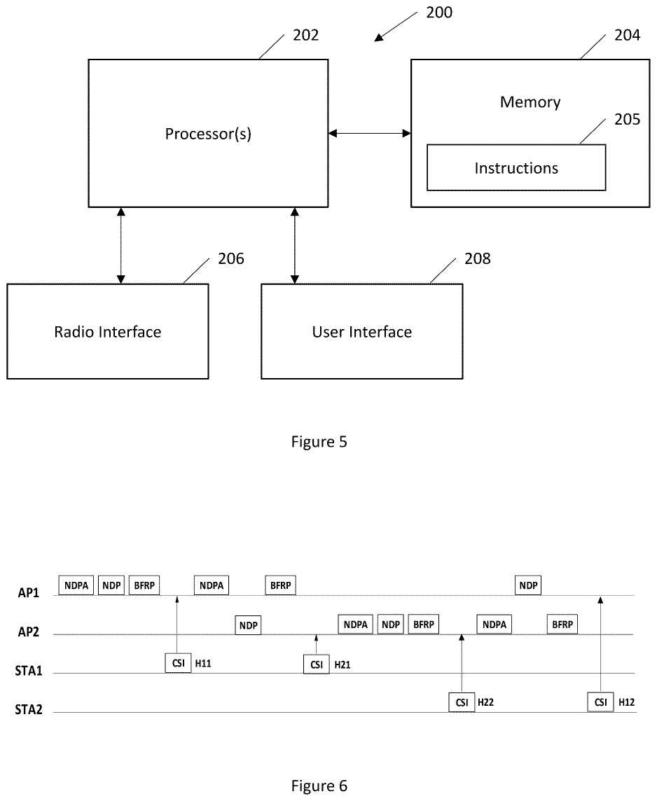

In some examples, the communications system 100 may support radiofrequency sensing during IFS. In some examples, the communications system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The network manager may include a processor and/or a memory (e.g., such as a processor 205 and/or a memory 210, further described with respect to FIG. 5). The processor 205 may be used to execute instructions stored in the memory 210 and/or to store information in the memory 210, for example, such as the results of the executed instructions.

The Wi-Fi APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver.

An apparatus 200 may be implemented by a user device to which resources on the access interface are allocated and assigned, and thus any feature described herein with a user device may be implemented with a corresponding apparatus, such as the apparatus 200. The Wi-Fi AP 110 may further include a processor (e.g., such as the processor 205) and a memory (e.g., such as the memory 210). The processor 205 may be used to execute instructions stored in the memory 210 and/or to store information in the memory 210, for example, such as the results of the executed instructions.

The apparatus 200 may be configured to function as the cloud network 105, APs 110, client devices 115 and/or 120, and/or other entities. As shown in FIG. 5, the apparatus includes, is associated with, and/or is in communication with: a processor 205, a memory 210, and a communication interface 215. The processor 205 may be in communication with the memory device 210 via a bus for passing information among components of the apparatus 200. The memory device 210 may be non-transitory and may include, for example, one or more volatile and/or non-volatile memories. In other words, for example, the memory device 210 may be an electronic storage device (e.g., a computer readable storage medium) comprising gates configured to store data (e.g., bits) that may be retrievable by a machine (e.g., a computing device like the processor). The memory device 210 may be configured to store information, data, content, applications, instructions, or the like for enabling the apparatus to carry out various functions in accordance with an example embodiment of the present disclosure. For example, the memory device 210 could be configured to buffer input data for processing by the processor. Additionally or alternatively, the memory device 210 may be configured to store instructions for execution by the processor 205.

FIG. 5 shows, by way of example, a block diagram of an apparatus 200. The apparatus 200 comprises, for example, at least one processor 202 and at least one memory 204 storing instructions 205 that, when executed by the at least one processor, cause the apparatus 200 at least to perform the method or methods as disclosed herein, and any of the embodiments thereof. In an example, the at least one memory and the instructions (e.g. a computer program code, software), are configured, with the at least one processor, to cause the apparatus 200 to perform the method or methods as disclosed herein, and any of the embodiments thereof.

A processor 202 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 204 may be implemented using any suitable data storage technology. The memory may comprise a database for storing data. The memory 204 may be at least in part external to apparatus 200 but accessible to apparatus 200.

The instructions 15 may be comprised in a computer readable medium or a non-transitory computer readable medium. A term non-transitory, as used herein, is a limitation of the medium itself (i.e. tangible, not a signal) as opposed to a limitation on data storage persistency (e.g. random access memory, RAM, vs. read only memory, ROM).

The apparatus 200 comprises a radio interface 206. The radio interface 206 may provide the apparatus 200 with communication capabilities. The radio interface 206 may comprise a receiver configured to receive information in accordance with at least one cellular or non-cellular standard. The radio interface 206 may comprise a transmitter configured to transmit information in accordance with at least one cellular or non-cellular standard. The receiver may comprise more than one receiver. The transmitter may comprise more than one transmitter. The radio interface 206 may comprise a transceiver configured to receive and transmit information in accordance with at least one cellular or non-cellular standard. The transceiver may comprise more than one transceiver.

The apparatus 200 may optionally comprise a user interface 208 comprising, for example, at least one of a keypad, a microphone, a touch display, a display, a speaker, etc. The user interface 208 may be used to control the apparatus by the user. The user interface 208 may be external to the apparatus 200. For example, the apparatus 200 may be connected to another device, such as a computer, either via wireless or wired connection, and the apparatus 200 is controlled by the user via the computer.

The apparatus 200 may be embodied by or otherwise associated with a station, e.g., a user equipment or other client device. In another embodiment, the apparatus is comprised in such a station, e.g. as a chipset configured to control the station. The apparatus 200 embodied by or otherwise associated with a station may be caused or configured to perform at least the method of FIG. 8 and/or any one or more of the embodiments described.

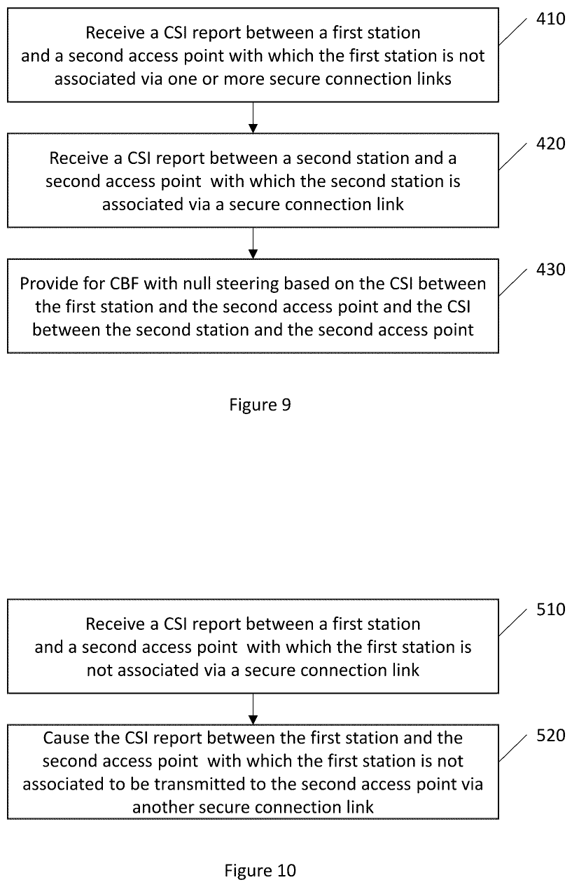

Alternatively, the apparatus 200 may be embodied by or otherwise associated with an access point. As another example, the apparatus is comprised in such an access point, e.g. as a chipset configured to control the access point. The apparatus 200 embodied by or otherwise associated with an access pointmay be caused or configured to perform at least the method of FIG. 9 and/or any one or more of the embodiments described.

Still further, the apparatus 200 may be embodied by or otherwise associated with an intermediate device, such as an intermediate station or an intermediate access point configured to relay a CSI report to another device. In another embodiment, the apparatus is comprised in such a station, e.g. as a chipset configured to control the intermediate device. The apparatus 200 embodied by or otherwise associated with an intermediate device be caused or configured to perform at least the method of FIG. 10 and/or any one or more of the embodiments described.

Although the Wi-Fi specification only accounts for a single access point performing a sounding procedure for one, two or more stations, several techniques have been proposed for conducting sounding between multiple access points and multiple stations. In one technique, a sequential sounding approach provides for separate sounding between each of the pairs of access points and stations. As shown in FIG. 6, the stations are sounded separately with each access point transmitting its NDP sequentially to a respective station such that the respective station then sends the CSI to the access point that transmitted the NDP. This process is repeated for each station. In FIG. 6, STA1 first sends the CSI designated H11 to AP1 in response to an NDP from AP1 before sending the CSI designated H21 to AP2 in response to an NDP from AP2. The process is then repeated with respect to STA2 with STA2 first sending the CSI designated H22 to AP2 before sending the CSI designated H12 to AP1.

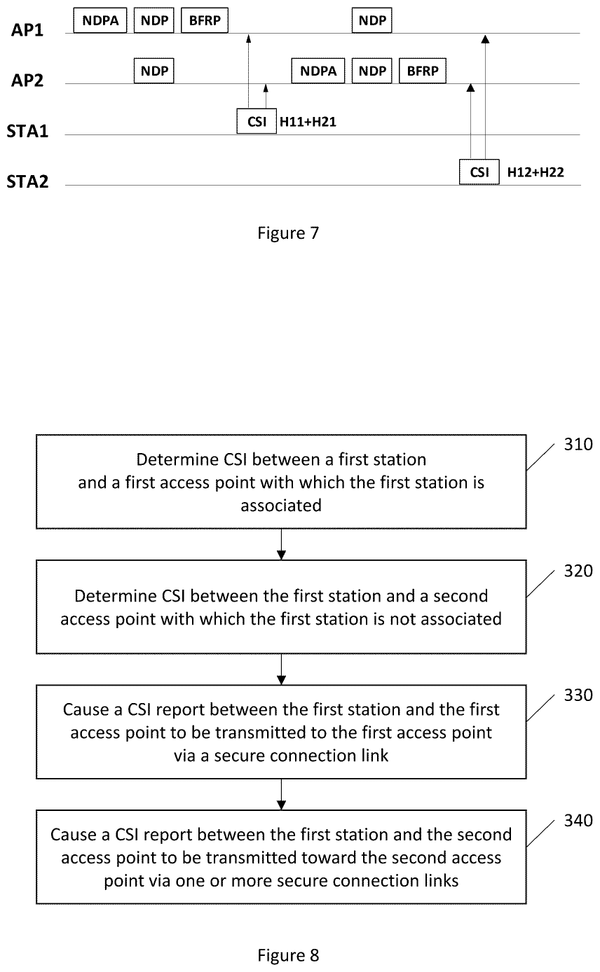

In another technique, joint sounding is conducted in which the access points transmit their NDPs concurrently to a respective station and then listen to concurrently receive a CSI frame from the respective station. This process is then repeated for each station. As shown in FIG. 7, AP1 and AP2 transmit an NDP at the same time to STA1. STA1 then sends its CSI designated H11 for the communication channel with AP1 to APQ and also sends its CSI designated H21 for the communication channel with AP2 to AP2. After AP1 and AP2 again concurrently transmit an NDP to STA2, STA2 then sends its CSI designated H12 for the communication channel with AP1 to AP1 and also sends its CSI designated H22 for the communication channel with AP2 to AP2. Regardless of whether sequential or joint sounding is employed, each access point will receive the CSI from each station such that each access point can then perform CBF with nulling, such as by appropriately configuring precoding vectors, so as to communicate with the stations associated with the access point while avoiding the creation of interference with other stations that are not associated with the respective access point.

In the techniques described above involving sounding between multiple access points and multiple stations, certain CSI is transmitted via unsecured connection links, such that the CSI is not encrypted. For example, CSI transmitted from a station to an access point with which the station is not associated will be transmitted via an unsecured connection link in the techniques described above, thereby potentially exposing the CSI and permitting the station to be tracked.

With respect to sequential sounding as depicted in FIG. 6, the CSI designated H21 measured on the channel between AP2 and STA1 is transmitted from STA1 to AP2. Similarly, the CSI designated H12 measured on the channel between AP1 and STA2 is transmitted from STA2 to AP1. However, STA1 is not associated with AP2 (but instead STA1 is associated with AP1) and STA2 is not associated with AP1 (but instead STA2 is associated with AP2). As such, the CSI provided by a station to an access point with which the station is not associated is not protected, that is, is not encrypted. In the embodiment of FIG. 6, the CSI designated H21 transmitted from ST1 to AP2 and the CSI designated H12 has transmitted from STA2 to AP1 can be detected and decoded by a third party station, thus exposing identity-related information regarding the station transmitting the CSI and introducing a privacy risk. Conversely, the CSI measured on the channel between an access point and its associated station and then returned from the station to the access point with which the station is associated, such as the CSI designated H11 provided by STA1 to AP1 and the CSI designated H22 provided from STA2 to AP2 can be protected, that is, can be encrypted, due to the key exchange that takes place between the access points and their associated stations.

The joint sounding technique as depicted in FIG. 7 can also expose CSI and create a privacy risk. In this regard, a station transmits the CSI measured during the NPD transmission from AP1 as well as from AP2 to multiple access points, e.g., AP1 and AP2. The CSI that is transmitted to an access point from an unassociated station, such as the CSI sent from STA1 to AP2 and the CSI sent from STA2 to AP1 is not protected, such that identity-related information regarding a station is exposed creating a privacy risk.

A method, apparatus 200 and computer program product are therefore provided in order to provide a CSI report from a station to an access point with which the station is unassociated while protecting the privacy of the CSI report. In this regard, even though the CSI report is to be transmitted from a station to an access point with which the station is unassociated, the CSI report will be transmitted via one or more secure connection links, such as by being encrypted while being transmitted via one or more connection links as provided, for example, by WiFi Direct. As such, the CSI report may transmitted be in a manner that does not expose the CSI report via an unsecured connection link to a third party, thereby protecting the privacy of the CSI report.

From the perspective of an apparatus 200 embodied by or otherwise associated with a station that determines and then reports the CSI for a communication channel between the station and an access point, the apparatus may be configured to cause a CSI report to be transmitted from the station to an access point with which the station is unassociated via one or more secure connection links. As shown in block 320 of FIG. 8, the apparatus 200 includes means, such as the at least one processor 202 or the like, for determining a CSI between a first station and a second access point with which the first station is unassociated. The apparatus 200 also includes means, such as the at least one processor 202, a radio interface 206 or the like, for causing a report of the CSI between the first station and the second access point to be transmitted from the first station toward the second access point with which the first station is unassociated via one or more secure connection links, thereby protecting the privacy of the report of the CSI between the first station and the second access point even though the first station and the second access point are unassociated. See block 340.

As also shown in block 310 of FIG. 8, the apparatus 200 embodied by a station can additionally include means, such as the at least one processor 202 or the like, for determining the CSI between the first station and the first access point with which the first station is associated. In this embodiment, the apparatus 200 also includes means, such as the processor 202, the radio interface 206 or the like, for causing the report of the CSI between the first station and the first access point to be transmitted to the first access point via a secure connection link. See block 330.

From the perspective of an apparatus 200 embodied by or otherwise associated with an access point, e.g., a second access point, that receives a CSI report from a station that is not associated with the access point via one or more secure connection links, the apparatus 200 includes means, such as the at least one processor 202, a radio interface 206 or the like, for receiving a report of CSI for the communication channel between a first station and the second access point with which the first station is unassociated via one or more secure connection links, as shown in block 410 in FIG. 9. By receiving the CSI report via secure connection links, the privacy of the CSI report is protected even though the first station and the second access point are unassociated. As shown in block 430 of FIG. 9, the apparatus 200 also includes means, such as the at least one processor 202, the radio interface 206 or the like, for providing for coordinated beamforming (CBF) with null steering based at least in part upon the CSI for the communication channel between the first station and the second access point. In this regard, the second access point is configured by coordinated beamforming with null steering to communicate with one or more stations, including the second station that is associated with the second access point, while directing a null signal toward the station(s) that are not associated with the second access point, thereby avoiding or reducing interference for these other station(s).

As also shown in block 420 of FIG. 9, the apparatus 200 of this example embodiment may also include means, such as the at least one processor 202, the radio interface 206 or the like, for receiving from a second station a report of the CSI between the second station and the second access point with which the second station is associated via a secure connection link. In this embodiment, the CBF with null steering that is provided by the second access point is also based not only upon the CSI between the first station and the second access point, but also the CSI between the second station and the second access point.

As depicted in FIG. 10, an intermediate device, such as an intermediate access point or an intermediate station, is configured to receive the CSI report relating to the communication channel between a station and access point (both of which are distinct from the intermediate device) and then forwards the CSI report to the access point to which the CSI report relates, that is, the access point that defines an end point of the communication channel to which CSI report relates. In this embodiment, an apparatus 200 embodied by or otherwise associated with an intermediate device, such as an immediate access point or an intermediate station, includes means, such as at least one processor 202, a radio interface 206 or the like, for receiving, from a first station, a report of CSI between the first station and a second access point with which the first station is unassociated via a secure connection link between the first station and the intermediate device (such as between the first station and an intermediate station or between the first station and an intermediate access point with which the first station is associated). See block 510 of FIG. 10. As shown in block 520 of FIG. 10, the apparatus 200 also includes means, such as the at last one processor 202, the radio interface 206 or the like, for causing the report of the CSI between the second access point and the unassociated first station to be transmitted to the second access point via another secure connection link between the intermediate device and the second access point (such as between an intermediate access point and the second access point or between an intermediate station and the second access point with which the intermediate station is associated). As such, privacy protection is provided for the report of the CSI between the first station and the second access point. In one embodiment in which the apparatus 200 is embodied by a first access point having secure connection links with a first station and with a second access point, the apparatus may also include means, such as at least one processor 202, the radio interface 206 or the like, for communicating with the second access point to determine that the report of the CSI is to be provided by the first station.

The foregoing aspects are described in relation to FIGS. 8, 9 and 10 from the perspective of a station, an access point and an intermediate device, respectively. For purposes of illustration, the various embodiments are described in FIGS. 8-10 and hereinbelow in relation to the operations performed by first and second access points AP1 and AP2 and first and second stations STA1 and STA2. However, the reference to two access points and two stations is for purposes of example and not of limitation as other example embodiments may include three, four or more stations access points and/or three, four or more stations configured to operate in a comparable manner to that described herein.

By way of example, a station of one embodiment may provide a CSI report only to the access point with which the station is associated even though the CSI report relates, at least in part, to another access point. In this embodiment, the access point with which the station is associated is then configured to forward the CSI report that is associated with another access point to the other access point. As the connection links between the station and the access point with which the station is associated and between the access points are both secure, the CSI report is transmitted from a station to an access point with which the station is unassociated via only secure connection links, thereby preserving the privacy of the CSI report.

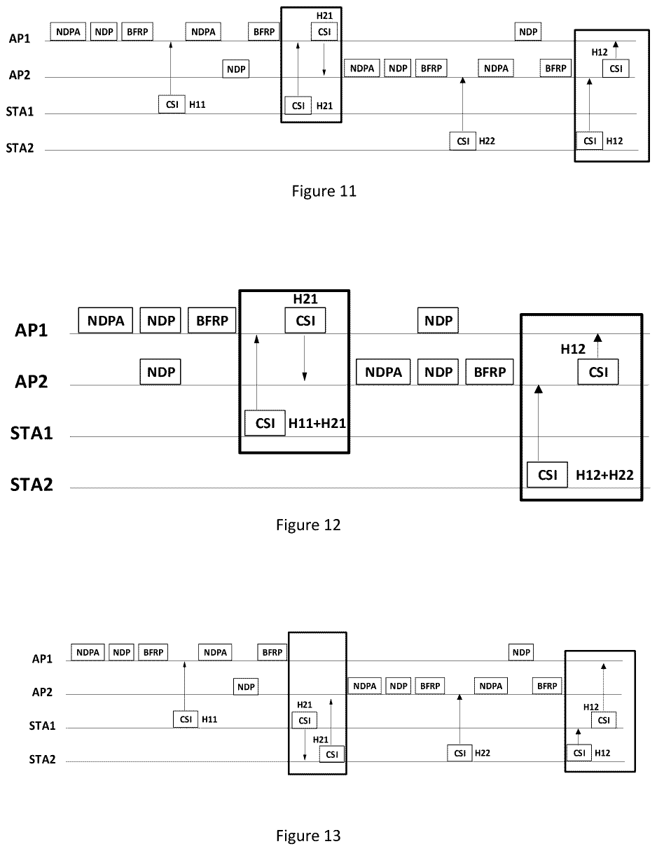

By way of example, a sequential embodiment is depicted in FIG. 11. As shown, in response to an NDP from AP1 to STA1, STA1 determines the CSI for the communication channel between STA1 and AP1 and then provides the CSI report designated H11 to AP1 via a secure connection link since STA1 is associated with AP1. In response to NDP from AP2 to STA1, STA1 measures the CSI for the communication channel between AP2 and STA1 and then provides the CSI report to AP1 with which STA1 is associated. As such, the CSI report relating to the communication channel between a AP2 and STA1 designated H21 can be provided to AP1 via secure connection link even though the CSI report relates to AP2 and not to AP1. AP1 can then forward the CSI report or otherwise provide information relating to the CSI for the communication channel between STA1 and AP2 to AP2, also via secure connection link between the access points. As such, the CSI report regarding a communication channel between STA1 and AP2, an access point with which STA1 is not associated, may be provided from STA1 to AP2 via secure connection links, thereby protecting the privacy of the CSI report even though the CSI report relates to a pair of unassociated stations and access points.

As also shown in FIG. 11, this process may then be repeated for STA2 with STA2 directly providing the CSI report designated H22 for the communication channel between STA2 and AP2 to AP2 with which STA2 is associated. However, the CSI report designated H12 for the communication channel between STA2 and AP1 may be first provided to AP2 via a secure connection link between STA2 and AP2 with which STA2 is associated. The CSI report H12 or information regarding the CSI from the CSI report H12 is then forwarded from AP2 to AP1 via another secure connection link between the access points. As such, STA2 can provide the CSI report designated H12 to AP1 with which STA2 is unassociated via a pair of secure connection links in order to protect the privacy of the CSI report.

As another example that utilizes joint sounding, FIG. 12 depicts the concurrent or joint provision of CSI reports for communication channels between a station and each of two access points with the CSI reports being provided by the station to the access point with which the station is associated. By jointly or concurrently providing the CSI reports for communication channels between a station and each of two access points, the CSI reports are provided without receipt of signaling from the access points between the times at which the CSI reports are provided. The access point that receives the CSI reports then forwards the CSI report that relates to the communication channel between the station and the other access point to the other access point. As such, the connection links between the station and the access point with which the station is associated and between the access points themselves are secure, thereby permitting the CSI reports to be encrypted and the information contained therein to be protected. As shown in FIG. 12, the CSI reports relating to the communication channel between STA1 and AP1 that is designated H11, and between STA1 and AP2 that is designated H21 are jointly or concurrently provided by STA1 to AP1 via a secure connection link between STA1 and AP1 with which STA1 is associated. AP1 then forwards the CSI report designated H21 relating to the communication channel between STA1 and AP2 to AP2. The communication link between the access points is also secure, thereby protecting the privacy of the CSI report transmitted by STA1 to AP2 which STA1 is unassociated. FIG. 12 also similarly illustrates that the CSI reports relating to the communication channel between STA2 and AP2 that is designated H22, and between STA2 and AP1 that is designated H12 are jointly or concurrently provided by STA2 to AP2 via a secure connection link between STA2 and AP2 with which STA2 is associated. AP2 then forwards the CSI report designated H12 relating to the communication channel between STA2 and AP1 to AP1. The communication link between the access points is also secure, thereby protecting the privacy of the CSI report transmitted by STA2 to AP1 which STA2 is unassociated.

In the embodiments of FIGS. 11 and 12, a first access point AP1 serves an intermediate access point in order to relay the CSI report from a first station STA1 to a second access point AP2. The first access point AP1 preserves the privacy of the CSI report as a result of the secure connection links established with the first station STA1 and also with the second access point AP2.

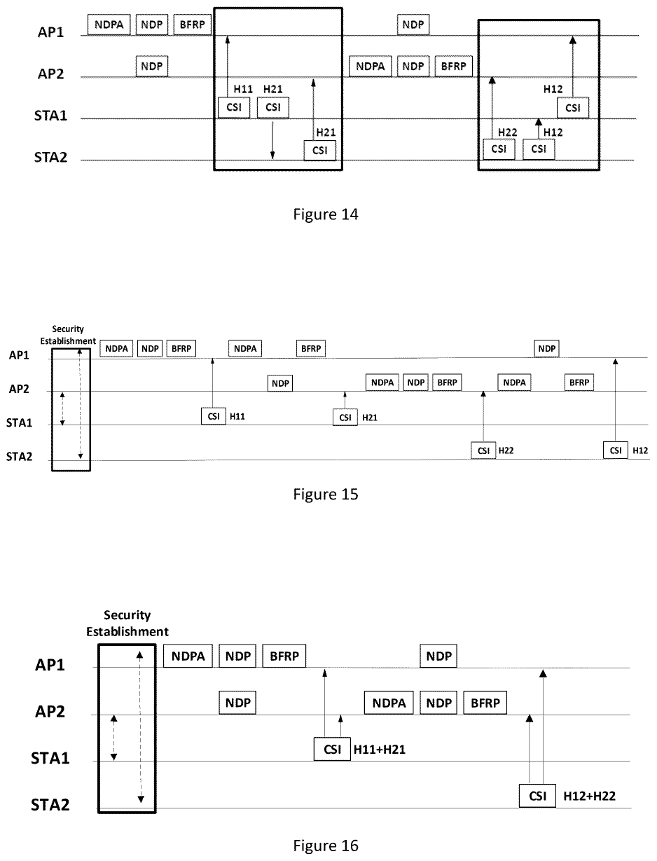

While the embodiments of FIGS. 11 and 12 rely upon an intermediate access point to relay the CSI report from a station which is associated with the intermediate access point to another access point with which the station is not associated, FIGS. 13 and 14 depict other example embodiments which rely upon an intermediate station to relay the CSI report from another station to an access point with which the intermediate station is associated. As the connection links between the stations and between the intermediate station and the access point are both secure, the CSI report is transmitted from a station to an access point with which the station is unassociated via only secure connection links, thereby preserving the privacy of the CSI report. As shown in the sequential sounding embodiment of FIG. 13, the CSI report designated H11 relating to the communication channel between the STA1 and AP1 is provided via a secure communication link from STA1 to AP1 with which STA1 is associated. However, the CSI report designated H21 relating to the communication channel between STA1 and AP2 (with which STA1 is not associated) is initially provided from STA1 to another (intermediate) station STA2 and is then relayed by STA2 to AP2 with which STA2 is associated. Since a secure connection link is established between the stations, that is, between STA1 and STA2, and also between STA2 and AP2 with which STA2 is associated, the CSI report designated H21 is provided by STA1 to AP2 with which STA1 is not associated via a pair of secure connection links, thereby protecting the privacy of the CSI report. Similarly, the CSI report designated H22 relating to the communication channel between the STA2 and AP2 is provided via a secure communication link from STA2 to AP2 with which STA2 is associated. However, the CSI report designated H12 relating to the communication channel between STA2 and AP1 (with which STA2 is not associated) is initially provided from STA2 to another (intermediate) station STA1 and is then relayed by STA1 to AP1 with which STA1 is associated. Since a secure connection link is established between the stations, that is, between STA1 and STA2, and also between STA1 and AP1 with which STA1 is associated, the CSI report designated H12 is provided by STA2 to AP1 with which STA2 is not associated via a pair of secure connection links, thereby protecting the privacy of the CSI report.

As shown in FIG. 14, the CSI report may also be relayed by an intermediate station in a joint sounding approach in which the CSI reports are provided to the respective access points without receipt of signaling from the access points between the times at which the CSI reports are provided. In this regard, a first station STA1 provides the CSI report designated H11 relating to the communication channel between STA1 and AP1 to AP1 via a secure connection link therebetween. In order to provide the CSI report designated H21 for the communication channel between STA1 and AP2 with which STA1 is unassocited, however, STA1 provides the CSI report designated H21 to STA2 via a secure communication link between the stations. STA2 then forwards the CSI report designated H21 relating to the communication channel between STA1 and AP2 to AP2 via the secure communication link established between STA2 and AP2 with which STA2 is associated, thereby protecting the privacy of the CSI report. Similarly, a second station STA2 may be configured to provide the CSI report designated H22 relating to the communication channel between STA2 and AP2 to AP2 via a secure connection link therebetween. In order to provide the CSI report designated H12 for the communication channel between STA2 and AP1 with which STA2 is unassocited, however, STA2 provides the CSI report designated H12 to STA1 via a secure communication link between the stations. STA1 then forwards the CSI report designated H12 relating to the communication channel between STA2 and AP1 to AP1 via the secure communication link established between STA1 and AP1 with which STA1 is associated, thereby protecting the privacy of the CSI report.

In the embodiments of FIGS. 13 and 14, a second station STA2 serves an intermediate access point in order to relay the CSI report from a first station STA1 to a second access point AP2. The second station STA2 preserves the privacy of the CSI report as a result of the secure connection links established with the first station STA1 and also with the second access point AP2.

In another embodiment, a security context is established between the stations and the access points that are not otherwise associated prior to transmitting the CSI report therebetween. The security context may be established in various manners including, for example, by defining one or more encryption keys that may be utilized by the stations and the access points that are not otherwise associated in order to protect the privacy of the CSI report transmitted therebetween. In an example embodiment, a signal may be received by one station from another station requesting establishment of the secure connection link between the other station and the access point with which the other station is unassociated. As a result of establishing a security context between the stations and the access points that are not otherwise associated, the CSI report may then be transmitted between a station and an access point via a secure communication link even though the station and the access point are not associated.

By way of example, FIG. 15 depicts an embodiment relating to a sequential sounding approach in which a security context is initially established between STA1 and AP2 and between STA2 and AP1, even though STA1 and AP2 are not associated with one another and STA2 and AP1 are not associated with one another. Thereafter, the CSI report designated H11 that is determined by STA1 with respect to the communication channel between STA1 and AP1 and the CSI report designated H21 that is separately determined by STA1 with respect to the communication channel between STA1 and AP2 can be provided by STA1 directly to AP1 and AP2, respectively, via the secure communication links that have been established therewith. Similarly, the CSI report designated H22 that is determined by STA2 with respect to the communication channel between STA2 and AP2 and the CSI report designated H12 that is separately determined by STA2 with respect to the communication channel between STA2 and AP1 can be provided by STA2 directly to AP1 and AP2, respectively, via the secure communication links that have been established therewith.

The establishment of a security context in order to provide for secure communication links between stations and access points that are not otherwise associated, such as secure communication links between STA1 and AP2 and between STA2 and AP1 may also be established in advance of a joint sounding technique as shown in FIG. 16. In this example embodiment, after having established the security context between the stations and the access points that are not otherwise associated, the CSI reports determined by STA1 with respect to AP1 and AP2 may be jointly or concurrently provided by STA1, such as by being provided without signaling from an access point to STA1 between the provision of the CSI reports by STA1. In this regard, the CSI report designated H11 is provided by STA1 to AP1 via a secure connection link as a result of the association between STA1 and AP1 and the CSI report designated H21 is provided directly from STA1 to AP2 via the secure connection link defined as a result of the security context established therebetween. Similarly, the CSI reports determined by STA2 with respect to AP1 and AP2 may also be jointly or concurrently provided by STA2 with the CSI report designated H22 being provided by STA2 to AP2 via a secure connection link as a result of the association between STA2 and AP2 and the CSI report designated H12 being provided directly from STA2 to AP1 via the secure connection link defined as a result of the security context established therebetween. As a result, a CSI report may be provided from a station directly to an access point with which the station is not associated via a secure connection link established as a result of the security context defined therebetween, thereby protecting the privacy of the CSI report.

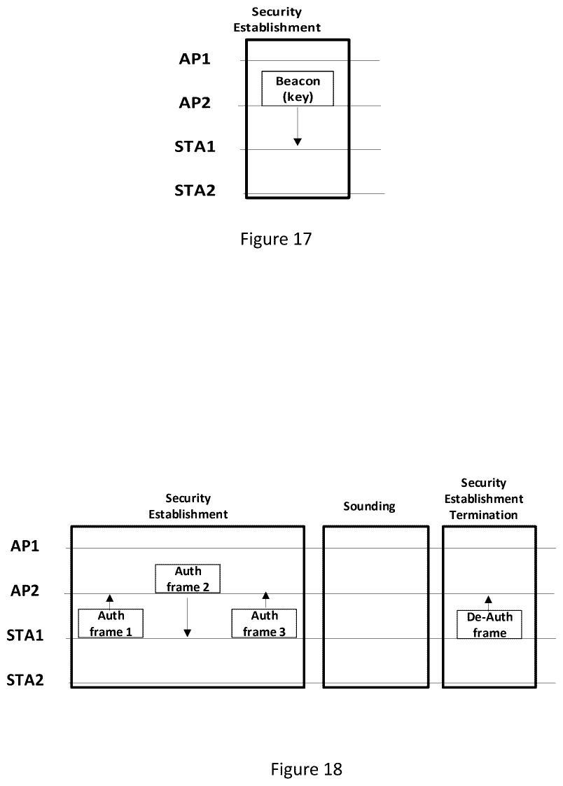

By establishing a security context between an unassociated station and access point, a security key is defined between the unassociated station and the access point such that the station can transmit the CSI report to the AP with which the station is unassociated in an encrypted manner, thereby protecting the privacy of the CSI report. The security context including the definition of a security key may be established in various manners. In one example in which the CSI report is to be sent from STA1 to AP2 with which STA1 is unassociated, either AP1 or AP2 can be configured to advertise the encryption key or content from which the encryption key may be generated in one or more beacon frames. The advertisement is such that STA1 is able to receive and process the advertisement even though STA1 is unassociated with AP2. By way of example, the advertisement may be a probe response or probe request. The encryption key or the content from which the encryption key may be generated may be the same for both AP1 and AP2. Alternatively, AP1 and AP2 can have unique encryption keys or provide content from which to generate unique encryption keys. By way of one example depicted in FIG. 17, AP2 is configured to advertise an encryption key in one or more beacon frames. The encryption key in this example embodiment may be a public key. STA1 is configured to receive the beacon frames and to utilize the encryption key to encrypt the CSI report that is subsequently provided from STA1 to AP2. By encrypting the CSI report, the privacy of the CSI report is protected even though the connection link between STA1 and AP2 would not otherwise have been secured.

In another embodiment, AP1 can receive the beacon frames including the encryption key from AP2. In this embodiment, AP1 can then provide the beacon frames including the encryption key that was received from AP2 to STA1 which can then utilize the encryption key to encrypt the CSI report provided from STA1 to AP2. By utilizing AP1 to relay the beacon frames including an encryption key from AP2 to STA1, the beacon frames may be transmitted via secure communication links, thereby further protecting the privacy of the encryption key.

In another embodiment depicted in FIG. 18, a security context may be established by the exchange of authentication frames between a station and an access point that are otherwise unassociated. For example, the unassociated station and access point may engage in a Pre-Association Security Negotiation (PASN) as defined in the 802.11az amendment. In PASN, STA1 transmits authentication frame 1 to initiate security establishment. AP2 replies to authentication frame 1 with authentication frame 2 and STA1 finishes the procedure with authentication frame 3. Following the authentication frame exchange, STA1 and AP2 possess the encryption key such that STA1 can encrypt the CSI report that is provided, such as during the sounding procedure of FIGS. 15 and 16, from SA1 to AP2. In some embodiments, the security establishment between STA1 and AP2 is temporary such that STA1 and AP2 can terminate the security establishment following the transmission of the CSI report from STA1 to AP2. In this example, the termination can be performed in response to a de-authentication frame transmitted by STA1 to AP2.

Although PASN may be utilized to generate the encryption key to be utilized by STA1 and AP2, STA1 and AP2 can exchange frames in accordance with other types of procedures in order to generate the encryption key that STA1 then utilizes to encrypt the CSI report relating to the communication channel between STA1 and AP2 to be transmitted to AP2. As a result of the establishment of a security context, the CSI report for a communication channel between a station and an access point that are unassociated may be transmitted directly from the station to the unassociated access point via a secure connection link, such as by transmitting an encrypted CSI report, to protect the privacy of the CSI report.

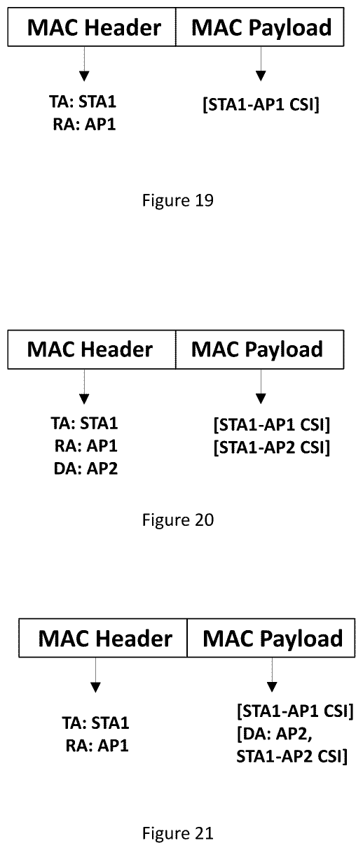

As described in the example embodiments above, communications may be provided between a station and an access point, between access points and between stations. Although the communication between any of the devices may be performed in a variety of different manners, examples of each different type of communication is provided below by way of example, but not of limitation. For example, in an instance in which a station sends a CSI report to an access point with which the station is associated, the station may include the CSI report in a management frame, such as an action frame, e.g., an ultra-high reliability (UHR) compressed beamforming frame/CQI frame. In an instance in which the station transmits a CSI report only for the access point with which the CSI is associated, the station may include a transmitter address (TA) and the receiver address (RA) in a Medium Access Control (MAC) header. As shown in FIG. 19, the transmitter address is the address of station, e.g., STA1, that transmits the CSI report and the receiver address is the address of the access point, e.g., AP1, to which the CSI report is directed. The CSI report for the communication channel between STA1 and AP1 may, in turn, be included in the MAC payload of the action frame, such as in one or more fields and/or one or more elements of the action frame.

In an embodiment in which the station includes the CSI report for the access point with which the station is associated as well as the CSI report for another access point with which the station is unassociated, the CSI reports may be provided by a UHR Extremely High Throughput (EHT) compressed beamforming frame/CQI frame that is defined and transmitted by the station. As shown in FIG. 20, the station can configure the MAC header to include the TA of STA1 and the RA of AP1 as well as the destination address (DA) for the CSI report intended for the other access point with which the station is not associated. In this example, their destination address (DA) is AP2 as the station STA1 also provides a CSI report for the communication channel between STA1 and AP2 with which the station is not associated. The CSI reports for both the communication channel between STA1 and AP1 and the communication channel between STA1 and AP2 can both be included in the MAC payload of the action frame. In this embodiment, both access points, that is, AP1 and AP2, will process the resulting frame as the frame has information in the form of a CSI report for both access points.

In another embodiment depicted in FIG. 21, the destination address DA of AP2, that is, the intended recipient of the CSI report for the communication channel between STA1 and AP2 with which STA1 is not associated, may be included in the MAC payload, instead of the MAC header. If included in the MAC payload, the destination address DA may be provided in association with the CSI report for the communication channel between STA1 and AP2.

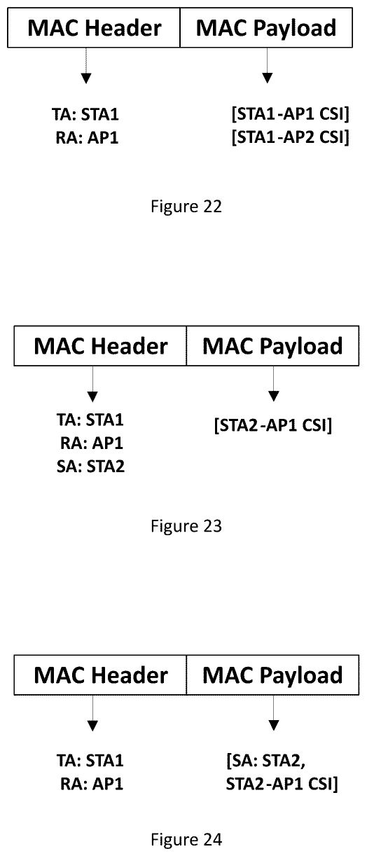

In another embodiment in which the access points are preconfigured to forward a CSI report that is received and is intended or related to another access point and in which the access points know the address of the other access points as a result of the preconfiguration, the destination address DA of the access point with which this station is not associated but for which the CSI report is intended need not be included in the frame. In this example embodiment depicted in FIG. 22, the MAC header may then include the TA of STA1 and the RA of AP1 and the MAC payload may include the CSI report for the communication channel between STA1 and AP1 and the CSI report for the communication channel between STA1 and AP2. However, this frame does not include a destination address for AP2. Instead, AP1 is preconfigured to forward the CSI report that relates to AP2, that is, the CSI report for the communication channel between STA1 and AP2, to AP2 upon receipt and processing of the frame including the MAC payload having the CSI report for the communication channel between STA1 and AP2.

In still other embodiments, such as an embodiment in which a station is serving as an intermediate device for relaying a CSI report to another station, a station may transmit a frame that includes the CSI report for another station, but no CSI report for the station that is transmitting the frame. In this example embodiment, the station STA1 transmitting the frame to an access point AP1 relating to a CSI report for a communication channel between another station STA2 and AP1 may include a TA of STA1, an RA of AP1 and a source address of STA2 in the MAC header as shown in FIG. 23. The source address identifies the station for which the CSI report relates even though the frame is transmitted by a different station STA1. The frame of this embodiment also includes a MAC payload with the CSI report for the communication channel between STA2 and AP1 with no CSI report involving STA1 even though STA1 is transmitting or relaying the frame to AP1. In an alternative embodiment depicted in FIG. 24, the source address may be included in the MAC payload, such as in association with the CSI report.

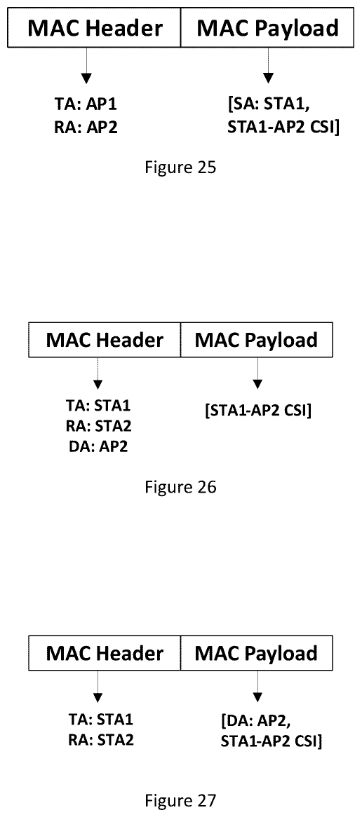

In regards to communication between access points, such as in an instance in which an intermediate access point forwards a CSI report to another access point to which the CSI report relates, a management frame, such as an action frame, may be defined for communication between access points. As such, the action frame may be termed in AP-to-AP UHR compressed beamforming frame/CQI frame. The frame of this example embodiment is a unicast frame directed to a particular access point and includes the CSI report for the access point to which the frame is directed. By way of example, the frame format can be defined as shown in FIG. 25 in which the MAC header includes a TA of AP1 and a RA of AP2 in which the frame is to be transmitted from AP1 to AP2. The MAC payload of this example frame includes the CSI report for the communication channel between STA1 and AP2 as well as the source address for STA1. As before, the source address indicates the address of another device, e.g., STA1, that provided the CSI report even though the other device is neither transmitting or receiving this frame. In this example embodiment, the CSI report relating to communication channel between STA1 and AP2 may initially be transmitted from STA1 to AP1 and then relayed by the frame as shown in FIG. 25 from AP1 to AP2

With respect to communications between stations, such as in an instance in which one intermediate station forwards the CSI report relating to another station to the other station, a frame may be defined to support the station to station communication. As such, a management frame, such as an action frame, may be defined that is termed a STA-to-STA UHR compressed beamforming frame/CQI frame. In this example embodiment depicted by FIG. 64, the frame may be defined to have a MAC header including a TA of STA1 and an RA of STA2 indicating that the frame is to be transmitted from STA1 to STA2. The MAC header may also include a DA of AP2 indicating that the eventual destination of this frame is AP2, such as accomplished by STA2 forwarding the frame or the CSI report contained by the frame to AP2 following receipt of the frame by STA2. The frame also includes a MAC payload including the CSI report for the communication channel between STA1 and AP2. In an alternative embodiment depicted in FIG. 27, the destination address (DA) of AP2 may be included in the MAC payload in association with the CSI report instead of in the MAC header. In either instance, the frame is transmitted from STA1 to STA2 and then is forwarded by STA2 to the destination address of AP2 such that AP2 receives the CSI report for the communication channel between STA1 and AP2 via secure communication links between STA1 and STA2 and also between STA2 and AP2 even though STA1 is not associated with a AP2.

Although a management frame may carry the CSI reports including the frames described above, control frames and or data frames may also or alternatively carry the CSI reports. As control frames do not include a MAC payload, the CSI information including the CSI reports may be included in the MAC header of a control frame along with the addressing information. As a data frame includes both a MAC header and a MAC payload, the addressing information and the CSI reports may be included in the MAC header and/or the MAC payload, such as described above with respect to management frames.

As described, a method, apparatus 200 and computer program product are therefore provided in order to provide a CSI report from a station to an access point with which this station is unassociated while protecting the privacy of the CSI report. Notwithstanding the fact that the CSI report is to be transmitted from a station to an access point with which the station is unassociated, the CSI report will be transmitted via one or more secure connection links, such as by being encrypted while being transmitted via one or more connection links as provided. As such, the CSI report may transmitted be in a manner that does not expose the CSI report via an unsecured connection link to a third party, thereby protecting the privacy of the CSI report.

FIGS. 8-10 are flowcharts illustrating a method according to an example embodiment. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 204 of an apparatus 200 employing an example embodiment and executed by at least one processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

As described above, at least some of the processes described herein may be carried out by an apparatus comprising means for carrying out at least some of the described processes. Means for performing method steps as disclosed herein may include software and/or hardware components of the apparatus 200. For example, the at least one processor 202, the memory 204, the instructions 205 and/or the radio interface 206 form means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

That which is claimed:

1. An apparatus comprising at least one processor and at least one memory storing instructions that, when executed by the at least one processor, cause the apparatus to perform at least:
determine channel state information (CSI) between a first station and a second access point with which the first station is unassociated; and
cause a report of the CSI between the first station and the second access point to be transmitted from the first station toward the second access point with which the first station is unassociated via one or more secure connection links to provide privacy protection for the report of the CSI between the first station and the second access point.

2. An apparatus according to claim 1, wherein the instructions, when executed by the at least one processor, further cause the apparatus to:
determine CSI between the first station and a first access point with which the first station is associated; and
cause a report of the CSI between the first station and the first access point to be transmitted to the first access point via a secure connection link.

3. An apparatus according to claim 1, wherein the instructions, when executed by the at least one processor, cause the apparatus to cause the report of the CSI between the first station and the second access point to be transmitted from the first station toward the second access point by causing the report of the CSI between the first station and the second access point to be transmitted from the first station to the first access point via a first secure connection link for subsequent provision from the first access point to the second access point via a second secure connection link.

4. An apparatus according to claim 2, wherein the instructions, when executed by the at least one processor, cause the apparatus to cause the report of the CSI between the first station and the first access point to be transmitted to the first access point and to cause the report of the CSI between the first station and the second access point to be transmitted from the first station toward the second access point by causing the reports of the CSI between the first station and the first access point and the CSI between the first station and the second access point to both be transmitted from the first station to the first access point via a first secure connection link for subsequent provision of the report of the CSI between the first station and the second access point from the first access point to the second access point via a second secure connection link.

5. An apparatus according to claim 1, wherein the instructions, when executed by the at least one processor, cause the apparatus to cause the report of the CSI between the first station and the second access point to be transmitted from the first station toward the second access point by causing the report of the CSI between the first station and the second access point to be transmitted from the first station to a second station via a first secure connection link for subsequent provision from the second station to the second access point via a second secure connection link.

6. An apparatus according to claim 2, wherein the instructions, when executed by the at least one processor, cause the apparatus to cause the report of the CSI between the first station and the first access point to be transmitted to the first access point and to cause the report of the CSI between the first station and the second access point to be transmitted toward the second station without receipt of signaling from the first and second access points therebetween.

7. An apparatus according to claim 1, wherein the instructions, when executed by the at least one processor, further cause the apparatus to establish a secure connection link between the first station and the second access point with which the first station is unassociated prior to causing the report of the CSI between the first station and the second access point to be transmitted from the first station toward the second access point by causing the report of the CSI between the first station and the second access point to be transmitted to the second access point via the secure connection link established therebetween.

8. An apparatus according to claim 2, wherein the instructions, when executed by the at least one processor, further cause the apparatus to establish a secure connection link between the first station and the second access point with which the first station is unassociated prior to causing the reports of the CSI between the first station and the first access point and between the first station and the second access point to be transmitted to the first access point and the second access point, respectively, without receipt of signaling from the first and second access points therebetween.

9. An apparatus according to claim 8, wherein the instructions, when executed by the at least one processor, further cause the apparatus to receive a signal from the first access point requesting establishment of the secure connection link between the first station and the second access point with which the first station is unassociated.

10. An apparatus comprising at least one processor and at least one memory storing instructions that, when executed by the at least one processor, cause the apparatus to perform at least:
receive a report of channel state information (CSI) between a first station and a second access point with which the first station is unassociated via one or more secure connection links to provide privacy protection for the report of the CSI between the first station and the second access point; and
provide for coordinated beamforming (CBF) with null steering based at least in part upon the CSI between the first station and the second access point.

11. An apparatus according to claim 10, wherein the instructions, when executed by the at least one processor, further cause the apparatus to receive, from a second station, a report of the CSI between the second station and the second access point with which the second station is associated via a secure connection link, and wherein the CBF with null steering is also based at least in part upon the CSI between the second station and the second access point.

12. An apparatus according to claim 10, wherein the instructions, when executed by the at least one processor, cause the apparatus to receive the report of the CSI between the first station and the second access point from a first access point via a secure connection link between the first and second access points.

13. An apparatus according to claim 10, wherein the instructions, when executed by the at least one processor, cause the apparatus to receive the report of the CSI between the first station and the second access point from the second station via the secure connection link between the second station and the second access point.

14. An apparatus according to claim 9, wherein the instructions, when executed by the at least one processor, further cause the apparatus to establish a secure connection link between the first station and the second access point with which the first station is unassociated prior to receiving the report of the CSI between the first station and the second access point from the first station via the secure connection link established therebetween.

15. An apparatus comprising at least one processor and at least one memory storing instructions that, when executed by the at least one processor, cause the apparatus to perform at least:
receive, from a first station, a report of channel state information (CSI) between the first station and a second access point with which the first station is unassociated via a secure connection link; and
cause the report of the CSI between the first station and the second access point with which the first station is unassociated to be transmitted to the second access point via another secure connection link so as to provide privacy protection for the report of the CSI between the first station and the second access point.

16. An apparatus according to claim 15, wherein the apparatus is embodied by a first access point having secure connection links with the first station and with the second access point.

17. An apparatus according to claim 16, wherein the instructions, when executed by the at least one processor, cause the apparatus to communicate with the second access point to determine that the report of the CSI is to be provided by the first station.

18. An apparatus according to claim 15, wherein the instructions, when executed by the at least one processor, further cause the apparatus to receive, from the first station, a report of the CSI between the first station and a first access point with which the first station is associated via a secure connection link.

19. An apparatus according to claim 18, wherein the instructions, when executed by the at least one processor, cause the apparatus to receive the report of the CSI between the first station and the first access point and to receive the report of the CSI between the first station and the second access point without additional signaling therebetween.

20. An apparatus according to claim 15, wherein the apparatus is embodied by a second station having secure connection links with the first station and the second access point.

21. A method comprising:
determining channel state information (CSI) between a first station and a second access point with which the first station is unassociated; and
causing a report of the CSI between the first station and the second access point to be transmitted from the first station toward the second access point with which the first station is unassociated via one or more secure connection links to provide privacy protection for the report of the CSI between the first station and the second access point.
